(19) United States
(12) Patent Application Publication
(10) Pub. No.: US 2004/0025521 A1
(43) Pub. Date: Feb. 12, 2004

(54) Coiled pipe device of an ice storage tank

(76) Inventor: Zhung-Ping Huang, Taichung (TW)

Correspondence Address: Zhung-Ping Huang, 58, MA YUAN WEST ST., TAICHUNG, TW

(21) Appl. No.: 10/216,473

(22) Filed: Aug. 6, 2002

(51) Int. Cl. F25D 3/00; F25D 17/02; C02F 1/22; B01D 9/04

(52) U.S. Cl. 62/59; 62/434

(57) ABSTRACT

A coiled pipe device is disposed in an ice storage tank. The coiled pipe device contains a brine therein. The coiled pipe device has an outer coiled pipe and an inner coiled pipe surrounded by the outer coiled pipe. The outer coiled pipe has a first brine inlet and a first brine outlet. The inner coiled pipe has a second brine inlet and a second brine outlet. A length of the outer coiled pipe is the same as the length of the inner coiled pipe.

### BACKGROUND OF THE INVENTION

The present invention relates to a coiled pipe device of an ice storage tank. More particularly, the present invention relates to a coiled pipe device which is disposed in an ice storage tank.

Referring to FIG. 1, an ice-stored air conditioning system has a refrigeration compressor 10, an ice/water conversion machine 11, a water pump 13, a solenoid valve 14, an air conditioning box 15, and an ice storage tank 12. A coiled pipe (not shown in the figure) is disposed in the ice storage tank 12. A brine is poured into the coiled pipe. The ice/water conversion machine 11 freezes the brine at a low temperature. When the temperature of the brine in the coiled pipe increases, the water pump 13 forces the brine to flow into the ice/water conversion machine 11. Therefore, water in the ice storage tank 12 will be frozen into ice. When the solenoid valve 14 is shut off, the brine will enter the air conditioning box 15 to perform heat exchange.

Referring to FIGS. 2 and 3, a conventional coiled pipe 21 is disposed in an ice storage tank 2. The conventional coiled pipe 21 has a brine inlet 20 and a brine outlet 3. A plurality of ice layers 22 surround the conventional coiled pipe 21. A spacing 23 between two ice layers 22 is very small.

### SUMMARY OF THE INVENTION

An object of the present invention is to provide a coiled pipe device which is disposed in an ice storage tank and the coiled pipe device has an outer coiled pipe and an inner coiled pipe in order to decrease pressures therein and shorten an ice forming period of time.

Accordingly, a coiled pipe device comprises an outer coiled pipe and an inner coiled pipe surrounded by the outer coiled pipe. The outer coiled pipe has a first brine inlet and a first brine outlet. The inner coiled pipe has a second brine inlet and a second brine outlet.

### BRIEF DESCRIPTION OF THE DRAWINGS

FIG. 1 is a diagram of an ice-stored air conditioning system;

FIG. 2 is a schematic view illustrating a conventional coiled pipe disposed in an ice storage tank of the prior art;

FIG. 3 is a sectional view of a conventional coiled pipe of the prior art;

FIG. 4 is a perspective view of a coiled pipe device of an ice storage tank of a preferred embodiment in accordance with the present invention;

FIG. 5 is a top plan view of a coiled pipe device of an ice storage tank of a preferred embodiment in accordance with the present invention;

FIG. 6 is a schematic view illustrating a brine flowing in a coiled pipe device of an ice storage tank of a preferred embodiment in accordance with the present invention;

FIG. 7 is a schematic view illustrating an inner structure of a coiled pipe device of an ice storage tank of a preferred embodiment in accordance with the present invention; and

FIG. 8 is a sectional view of a coiled pipe device of an ice storage tank of a preferred embodiment in accordance with the present invention.

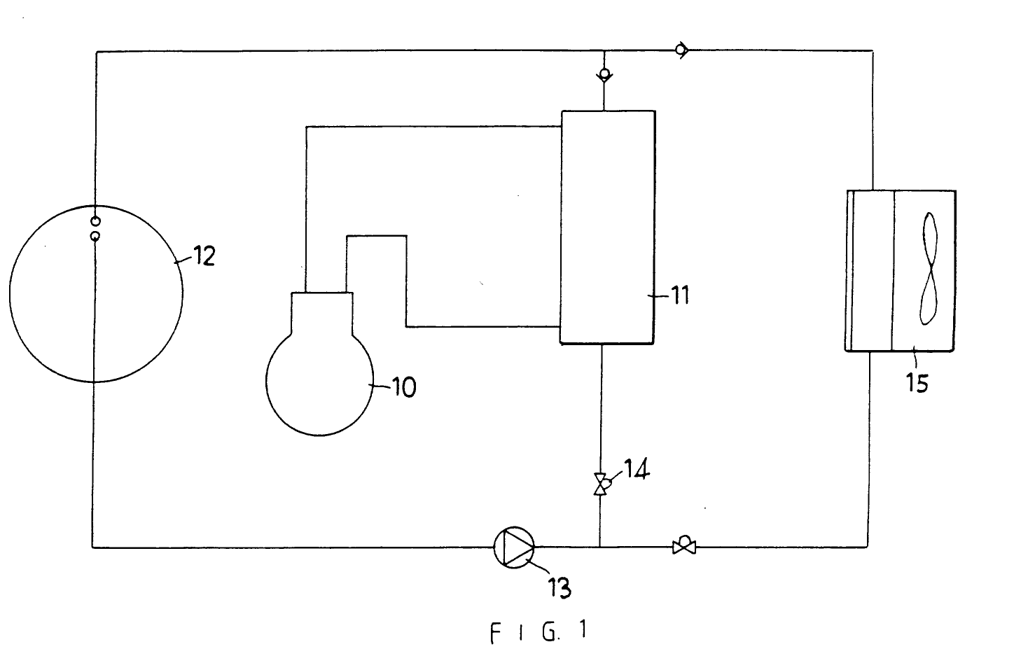

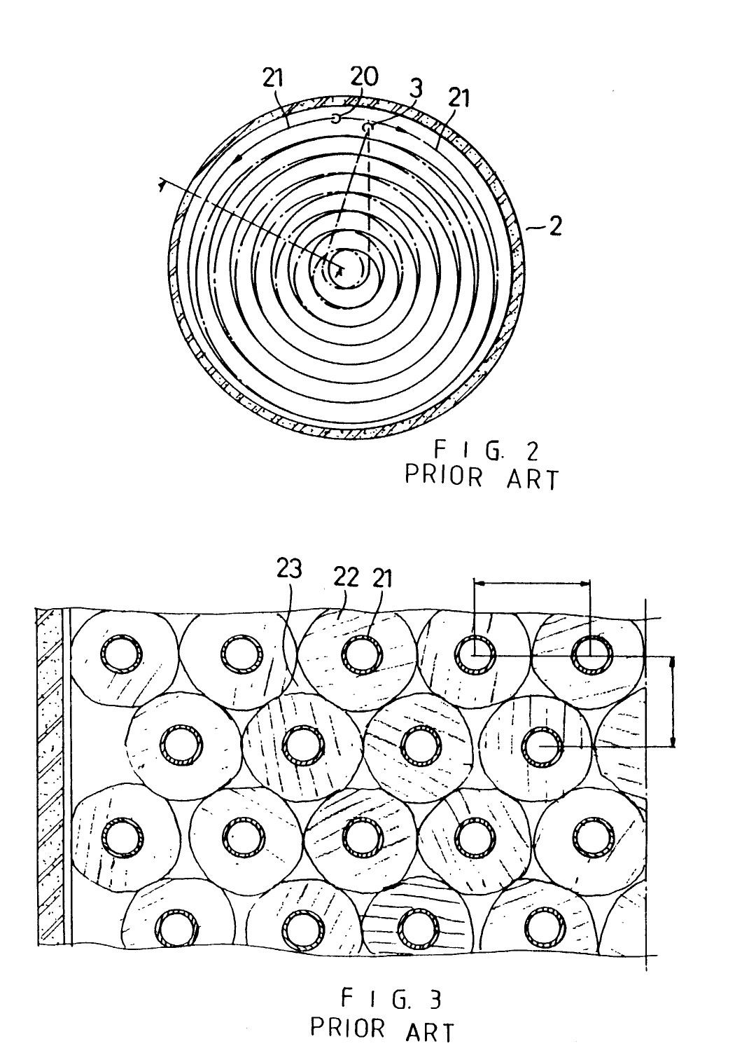

### DETAILED DESCRIPTION OF THE INVENTION

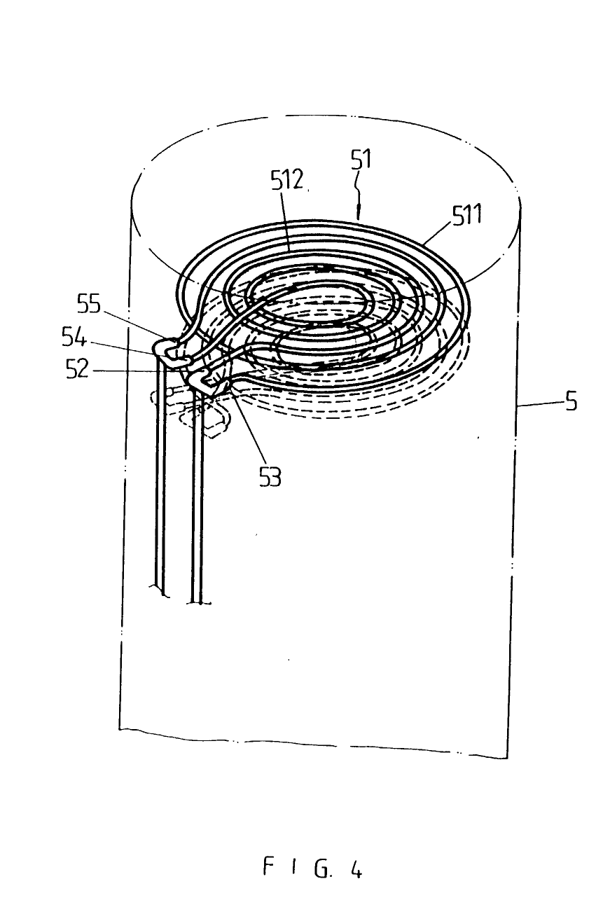

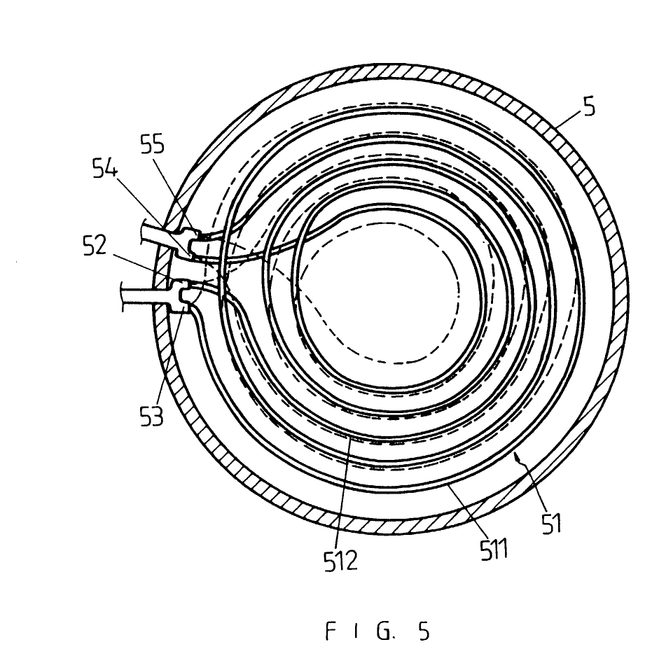

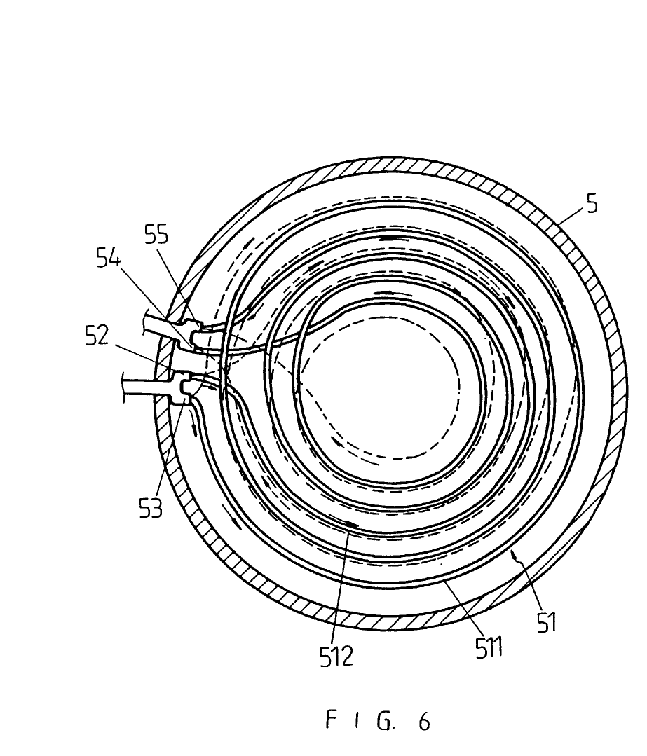

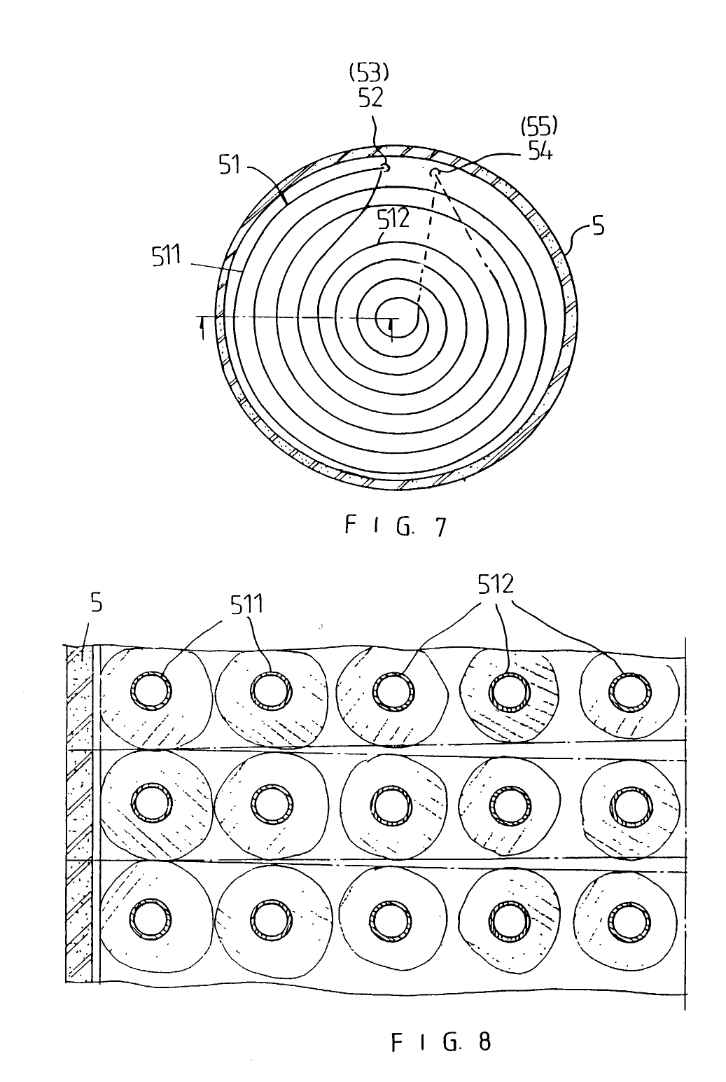

Referring to FIGS. 4 to 8, a coiled pipe device 51 is disposed in an ice storage tank 5.

The coiled pipe device 51 contains a brine therein (not shown in the figures).

The coiled pipe device 51 has an outer coiled pipe 511 and an inner coiled pipe 512 surrounded by the outer coiled pipe 511.

The outer coiled pipe 511 has a first brine inlet 52 and a first brine outlet 55.

The inner coiled pipe 512 has a second brine inlet 53 and a second brine outlet 54.

A length of the outer coiled pipe 511 is the same as the length of the inner coiled pipe 512.

A first layer of the outer coiled pipe 511 is wound clockwise.

A second layer of the outer coiled pipe 511 is wound counterclockwise.

A first layer of the inner coiled pipe 512 is wound clockwise.

A second layer of the inner coiled pipe 512 is wound counterclockwise.

Since a distance between the first brine inlet 52 and the first brine outlet 55 is short, an inner pressure of the outer coiled pipe 511 is decreased significantly. Therefore, an ice forming period of time in the ice storage tank 5 is shortened significantly. A water pump need not be used very often. Thus an energy is saved significantly.

Since a distance between the second brine inlet 53 and the second brine outlet 54 is short, an inner pressure of the inner coiled pipe 512 is decreased significantly. Therefore, an ice forming period of time in the ice storage tank 5 is shortened significantly. A water pump need not be used very often. Thus an energy is saved significantly.

The present invention is not limited to the above embodiment but various modification thereof may be made. Furthermore, various changes in form and detail may be made without departing from the scope of the present invention.

I claim:

1. A coiled pipe device comprises:
an outer coiled pipe,
an inner coiled pipe surrounded by the outer coiled pipe,
the outer coiled pipe having a first brine inlet and a first brine outlet, and
the inner coiled pipe having a second brine inlet and a second brine outlet.

2. The coiled pipe device as claimed in claim 1, wherein a length of the outer coiled pipe is the same as the length of the inner coiled pipe.

3. The coiled pipe device as claimed in claim 1, wherein a first layer of the outer coiled pipe is wound clockwise and a second layer of the outer coiled pipe is wound counterclockwise.

4. The coiled pipe device as claimed in claim 1, wherein a first layer of the inner coiled pipe is wound clockwise and a second layer of the inner coiled pipe is wound counterclockwise.
